(19) United States
(12) Patent Application Publication
(10) Pub. No.: US 2008/0272335 A1
(43) Pub. Date: Nov. 6, 2008

(54) Process for producing pellet or granular forms of polymer additives

(75) Inventors: Daniel Y. Shen, Irvine, CA (US); Luke Xuebin Yang, Irvine, CA (US); XueMing Yuan, Irvine, CA (US)

Correspondence Address: Crockett & Crockett, Suite 400, 24012 Calle De La Plata, Laguna Hills, CA, 92653, US

(73) Assignee: Dannier Chemical, Inc.

(21) Appl. No.: 11/724,764

(22) Filed: Mar. 15, 2007

Related U.S. Application Data
(60) Provisional application No. 60/743,494, filed on Mar. 15, 2006.

(51) Int. Cl. C08C 4/00; C08L 23/06; C08L 29/04; C08L 29/10

(52) U.S. Cl. 252/182.13; 524/543; 524/585

(57) ABSTRACT

A method for the production of a pellet or granular form of a polymer performance additive for the effective delivery of the active ingredient into the rubber or plastic manufacturing process. At least one polymer additive in the composition of 10% to 99% is combined with at least one binding additive in the composition of about 1% to 90%.

### RELATED APPLICATION

This present application claims priority from copending U.S. provisional patent application 60/743,494 filed Mar. 15, 2006.

### FIELD OF THE INVENTIONS

The process described below relates to a novel process for pellet or granular form production involving polymer additives such as pentachlorothiophenol (PCTP) and derivative zinc pentachlorothiophenol (ZnPCTP). Additives including PCTP and ZnPCTP dry powder form are converted into a powderless encapsulated pellet of varying mesh sizes and shapes.

### BACKGROUND OF THE INVENTION

In conventional peroxide-cure chemistry, polymer additives known as peptizers are a compound ingredient used to accelerate by chemical reaction the softening of rubber under the influence of mechanical action, heat, or both. Typically, polymer additives are manufactured as dry, fine dusty powders. Specific examples of polymer additives include the peptizers pentachlorothiophenol (PCTP) and derivative zinc pentachlorothiophenol (ZnPCTP). During various manufacturing stages in the rubber and plastics industry, workers must handle, weigh, add, or mix the powders. Handling of the powder exposes the workers to risk of explosion as well as exposure to inhale particulates.

In recent years, the commonly practiced method to produce or prepare polymers additives into a pelletized form required the use of the binding additive 1,4-cis-polybutadiene or rubber. The rubber is mixed with the active ingredient—a polymer additive such as PCTP and/or ZnPCTP as well as additional additives. In this process, the rubber is the binding additive, and is the major factor in making the pellets. In applications where the rubber binding additive is not an ingredient of the process or final goods, the rubber-based pellet production cannot be used. Therefore, there is a need for a new pellet production preparation or process that replaces the rubber as the binding additive from the preparation of the homogeneous composition.

### SUMMARY

The method relates to a process of producing polymer additives such as PCTP and derivative ZnPCTP in pellet or granular form without using rubber as the binding additive.

### DETAILED DESCRIPTION OF THE INVENTIONS

A process is described of a method for the production of a pellet or granular form of a polymer performance additive for the effective delivery of the active ingredient (polymer additive) in the rubber or plastic manufacturing process. At least one polymer additive in the composition of 10% to 99% is combined with at least one binding additive in the composition of about 1% to 90%. Examples of suitable polymer additives are PCTP and ZnPCTP. Examples of suitable binding additives or combination of binding additives are bee wax, paraffin, polyethylene glycol, poly vinyl alcohol, dioctyl phthalate, dibutyl phthalate, sodium laurylsulfate, AEO-9, NPE-10, carnauba wax, stearic acid, zinc salt, zinc stearate, polyethylene, 617 AC, 4-laurylbenzenesulfonic acid and sodium salt.

The homogeneous composition of polymer additive and binding additive ingredients are introduced into an extruder. The extruder contains a feeding hopper, a heated barrel with an internal rotating screw and a die. The homogeneous composition is introduced inside the barrel, heated and then forced by the screw to flow through a shaped opening in a die. The die sizes the material to a specific shape, thickness and width and then cut to size through a combination of specialized equipment to form a pellet or granule. The resulting pellet has a negligible effect on the rubber and plastic manufacturing process. As used herein, “negligible effect” means that the homogeneous composition of polymer and binding additives does not interfere with any step of the rubber or plastic manufacturing process because it completely melts and disperses at the same application temperature range as that of the masterbatch, and binding additives are compatible to that of the masterbatch and/or with little-to-no adverse effect on the overall manufacturing process.

A pellet or granule suitable for use in a plastic or rubber manufacturing process can be formed through the following process. In one example, 75% of the polymer additive powder pentachlorothiophenol is mixed with 25% of the binding additive or binding materials. The ingredients are mixed together in a mixer until they form a homogeneous powder composition and the mixed powder is then fed through an extrusion machine. The resulting pellets or granules have a density of approximately 1.46 g/cm³. The granular size is approximately 5-10 mm in length and approximately 3 mm in diameter. In another example, 75% of the polymer additive pentachlorothiophenol may be combined with 25% of the binding additive zinc stearate. The melting point for zinc stearate is 117° C. to 120° C. The resulting pellets have a softening temperature of approximately 75° C. to 80° C. In another example, 75% of the polymer additive pentachlorothiophenol may be combined with 25% of the binding additive polyethylene wax. The melting point for polyethylene wax is approximately 77.5° C. to 79° C. The resulting pellets have a softening temperature of approximately 48° C. to 55° C. In another example, 75% of the polymer additive pentachlorothiophenol may be combined with 25% of the binding additive stearic acid. The melting point for stearic acid is approximately 71° C. to 72° C. The resulting pellets have a softening temperature of approximately 45° C.

The production of the pellets or granules in the present method provides great advantages. First, the process does not require the use of rubber (1,4-cis-polybutadiene) as the binding additive for the preparation of the homogeneous composition. The replacement of the rubber allows the present pellets to be used in low working temperature applications. This provides the user more flexibility in the ability to design the manufacturing process for a variety of finished goods. Second, the present method is homogeneously mixed prior to extrusion and forming of pellets or granules. This assures the finished pellets to be of consistent quality and thus, with minimum variation in the rubber and plastic manufacturing process. Third, by replacement of the rubber with a homogeneous mix of polymer additive and binding additive, the present method provides a superior dispersion characteristic enabling the formed pellets to be more easily dispersed in a rubber manufacturing (mastication) or plastic manufacturing process. Fourth, the present method does not include any rubber, which may harden with age and shorten the shelf life of the finished pellet or granule—a recognized concern in the industry which leads to the rubber pellets becoming unusable. The present process forms pellets or granules that removes visco-elastic-related manufacturing problems because the dispersion of the pellet is not affected by shelf life or in pellets that exhibit the hardening problems previously associated with common rubber-based pellets.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A method of producing a polymer additive for use in a rubber or plastic manufacturing process, the method comprising:
selecting at least one polymer additive in the composition of 10% to 99%; and
combining the polymer additive with at least one binding additive selected from the group consisting of bee wax, paraffin, polyethylene glycol, poly vinyl alcohol, dioctylphthalate, dibutyl phthalate, sodium laurylsulfate, AEO-9, NPE-10, carnauba wax, stearic acid, zinc salt, zinc stearate, polyethylene, 617 AC, 4-laurylbenzenesulfonic acid and sodium salt,
wherein the amount of binding additive is from about 1% to 90%.

2. The method of claim 1 further comprising the step of forming a pellet that has a density of about 1.46 g/cm³, a length of between 5 to 10 mm and a diameter of about 3 mm.

3. The method of claim 1 further comprising the step of providing a polymer additive that is 75% of powder pentachlorothiophenol and the binding additive is 25% zinc stearate.

4. The method of claim 1 further comprising the step of providing a polymer additive that is 75% pentachlorothiophenol and the binding additive is 25% polyethylene wax.

5. The method of claim 1 further comprising the step of providing a polymer additive is 75% pentachlorothiophenol and the binding additive is 25% stearic acid.

6. A method of producing a polymer additive for use in a rubber or plastic manufacturing process, the method comprising:
selecting at least one polymer additive; and
combining the polymer additive with at least one binding additive selected from the group consisting of bee wax, paraffin, polyethylene glycol, poly vinyl alcohol, dioctylphthalate, dibutyl phthalate, sodium laurylsulfate, AEO-9, NPE-10, carnauba wax, stearic acid, zinc salt, zinc stearate, polyethylene, 617 AC, 4-laurylbenzenesulfonic acid and sodium salt, in an amount having a negligible effect on the softening of the pellet in the further processing step of a rubber or plastic manufacturing process.

7. The method of claim 6 further comprising the step of forming a pellet that has a density of about 1.46 g/cm³, a length of between 5 to 10 mm and a diameter of about 3 mm.

8. The method of claim 6 further comprising the step of providing a polymer additive that is 75% of powder pentachlorothiophenol and the binding additive is 25% zinc stearate.

9. The method of claim 6 further comprising the step of providing a polymer additive that is 75% pentachlorothiophenol and the binding additive is 25% polyethylene wax.

10. The method of claim 6 further comprising the step of providing a polymer additive that is 75% pentachlorothiophenol and the binding additive is 25% stearic acid.
